(19) United States
(12) Patent Application Publication
(10) Pub. No.: US 2005/0254543 A1
(43) Pub. Date: Nov. 17, 2005

(54) Lining for carbothermic reduction furnace

(75) Inventor: Johann Daimer, Morfelden-Walldorf (DE)

Correspondence Address: LERNER AND GREENBERG, PA, P O BOX 2480, HOLLYWOOD, FL, 33022-2480, US

(73) Assignee: SGL Carbon AG

(21) Appl. No.: 11/123,773

(22) Filed: May 5, 2005

Related U.S. Application Data
(60) Provisional application No. 60/571,604, filed on May 13, 2004.

(51) Int. Cl. H05H 1/00

(52) U.S. Cl. 373/18; 373/75

(57) ABSTRACT

An inner lining for the steel shell of a carbothermic reduction furnace for the production of alumina has a base layer of graphite and a coating layer of refractory material. The refractory material is corundum (Al₂O₃) bound by Sialon (Si.Al.O.N). The lining structure provides protection against the molten slag and it is not attacked by the CO-rich melt furnace atmosphere. Further, the lining does not contaminate the melt and it provides an effective heat dissipation system in case of a power shut-off.

### CROSS-REFERENCE TO RELATED APPLICATION

This application claims the benefit under 35 U.S.C. § 119 (e), of copending U.S. Provisional Application No. 60/571,604, filed May 13, 2004.

### BACKGROUND OF THE INVENTION

1. Field of the Invention

The present invention relates to linings and liners made of graphite and other refractory materials for the production of aluminum by carbothermic reduction of alumina.

2. Description of the Related Art

For a century the aluminum industry has relied on the Hall-Heroult process for aluminum smelting. In comparison with processes used to produce competing materials, such as steel and plastics, the process is energy-intensive and costly. Hence, alternative aluminum production processes have been sought.

One such alternative is the process referred to as direct carbothermic reduction of alumina. As described in U.S. Pat. No. 2,974,032 (Grunert et al.) the process, which can be summarized with the overall reaction
Al₂O₃+3C=2Al+3CO (1)
takes place, or can be made to take place, in two steps:
2Al₂O₃+9C═Al₄C₃+6CO (2)
Al₄C₃+Al₂O₃=6Al+3CO (3).
Reaction (2) takes place at temperatures between 1900 and 2000° C. The actual aluminum producing reaction (3) takes place at temperatures of 2200° C. and above; the reaction rate increases with increasing temperature. In addition to the species stated in reactions (2) and (3), volatile Al species including Al₂O are formed in reactions (2) and (3) and are carried away with the off gas. Unless recovered, these volatile species represent a loss in the yield of aluminum. Both reactions (2) and (3) are endothermic.

Various attempts have been made to develop efficient production technology for the direct carbothermic reduction of alumina (cf. Marshall Bruno, Light Metals 2003, TMS (The Minerals, Metals & Materials Society) 2003). U.S. Pat. No. 3,607,221 (Kibby) describes a process in which all products quickly vaporize to essentially only gaseous aluminum and CO, containing the vaporous mixture with a layer of liquid aluminum at a temperature sufficiently low that the vapor pressure of the liquid aluminum is less than the partial pressure of the aluminum vapor in contact with it and sufficiently high to prevent the reaction of carbon monoxide and aluminum and recovering the substantially pure aluminum.

Other patents relating to carbothermic reduction to produce aluminum include U.S. Pat. No. 4,486,229 (Troup et al.) and U.S. Pat. No. 4,491,472 (Stevenson et al.). Dual reaction zones are described in U.S. Pat. No. 4,099,959 (Dewing et al.). More recent efforts by Alcoa and Elkem led to a novel two-compartment reactor design as described in U.S. Pat. No. 6,440,193 (Johansen et al.).

In the two-compartment reactor, reaction (2) is substantially confined to a low-temperature compartment. The molten bath of Al₄C₃ and Al₂O₃ flows under an underflow partition wall into a high-temperature compartment, where reaction (3) takes place. The thus generated aluminum forms a layer on the top of a molten slag layer and is tapped from the high-temperature compartment. The off-gases from the low-temperature compartment and from the high-temperature compartment, which contain Al vapor and volatile Al₂O are reacted in a separate vapor recovery units to form Al₄C₃, which is re-injected into the low-temperature compartment. The energy necessary to maintain the temperature in the low-temperature compartment can be provided by way of high intensity resistance heating such as through graphite electrodes submerged into the molten bath. Similarly, the energy necessary to maintain the temperature in the high-temperature compartment can be provided by a plurality of pairs of electrodes substantially horizontally arranged in the sidewalls of that compartment of the reaction vessel.

U.S. Pat. No. 4,099,959 (Dewing et al.) proposed using a steel shell without any inner lining for the reaction vessel. During furnace operation, a lining of frozen slag would form on the steel, thus protecting it from the harsh environment inside the reaction chamber and furthermore preventing electrical short-circuiting. Nonetheless, in order to ensure the safety of the system and to avoid the possibility of breakthrough of molten slag, it was suggested to provide features such as two duplicate and completely independent water cooling systems, infra-red radiation detectors or other temperature sensors which monitor the steel shell, as well as current detectors in the electrical grounding connection to the steel shell. When the detectors detect any malfunctioning of the system, power is automatically turned off and the redundant water cooling system is turned on.

Besides the complexities is that operations safety system, the frozen slag layer is only formed after some initial start-up procedures during which the steel shell would be heavily attacked by the molten slag. In addition, the melt furnace atmosphere is under pressure and contains substantial amounts of CO gas which easily diffuses through the frozen slag and then attacks the steel surface. Furthermore, it is very difficult to maintain a uniform layer of the frozen slag under real operational conditions. Hence, the above-described safety system would regularly cause power shut-offs making it difficult to run an efficient and continuous production process. Finally, once the extremely hot molten slag reaches the steel shell it is a difficult task to cool the system down by the mere use of water spraying devices.

### SUMMARY OF THE INVENTION

It is accordingly an object of the invention to provide a liner for a carbothermic reduction furnace which overcomes the above-mentioned disadvantages of the heretofore-known devices and methods of this general type. Specifically, the object is to provide inner linings to the steel shell of carbothermic reduction furnaces for the production of alumina, in particular linings made of refractory material and graphite, which provide protection against the molten slag, which do not contaminate the melt, which are not attacked by the CO-rich melt furnace atmosphere, and which provide an effective heat dissipation system in case of a power shut-off.

With the foregoing and other objects in view there is provided, in accordance with the invention, a reactor vessel for a carbothermic reduction furnace, in particular for the carbothermic reduction of alumina. The vessel comprises:
an outer shell having an inner wall surface; and
a lining structure disposed on the inner wall surface and protecting the outer shell against attack from molten slag inside the reactor vessel, the lining having a relatively thick base layer of graphite disposed on the inner wall surface and a relatively thin refractory material layer on the base layer of graphite and in intimate contact therewith.

The lining structure has a thermal conductivity of at least 35 W/m·K and, preferably, within the range of between 120 W/m·K and 200 W/m·K.

The lining structure is specifically configured for carbothermic reduction of alumina. The outer shell is a steel shell and the lining structure is formed to protect the molten slag of alumina against iron contamination from the steel shell and the steel shell against CO attack. The lining structure is preferably configured to be substantially resistant to CO attack and to have a low Fe content of less than 0.1% by weight.

In accordance with an added feature of the invention, the refractory material layer is a corundum layer. Preferably, the corundum layer is formed of corundum and approximately 25% by weight Sialon.

The corundum layer may be formed as a coating layer or it may be formed of a plurality of thin corundum tiles attached to the base layer of graphite with a high-temperature glue based on graphite particles dispersed in a resin (e.g., phenolic resin, furanic, epoxy).

With the above and other objects in view there is also provided, in accordance with the invention, a method of producing a lining structure for a carbothermic reduction furnace. The method comprises:
mixing a major proportion of calcined low-iron coke with a minor proportion of pitch at a temperature above a softening point of the pitch and forming (e.g., extruding) the mixture into one or more blocks;
calcining the blocks to form calcined blocks;
impregnating the calcined blocks with impregnation pitch, rebaking the impregnated blocks, calcining the blocks, and machining the calcined blocks;
coating at least one surface of each of the blocks with a slurry comprising ground corundum, and heat treating the slurry to form a refractory coating on and in intimate contact with the at least one surface of the graphite blocks; and
joining the blocks to form a solid lining of a carbothermic reduction furnace, with the surface having the refractory coating facing an interior of the furnace.

In accordance with an additional feature of the invention, the mixing step comprises providing approximately 82 parts of anode grade coke and approximately 18 parts pitch and mixing at a temperature of approximately 150° C.

In accordance with another feature of the invention, the coating step comprises coating with a slurry of approximately 75% finely ground corundum and approximately 25% Sialon particles, and heat treating the slurry at a temperature of approximately 2500° C.

In accordance with a further feature of the invention, the graphite block is calcined at a calcining temperature above 2800° C.

In sum, the invention provided for linings made of graphite and other refractory material for the production of aluminum by carbothermic reduction of alumina. The graphite linings are in direct contact with an outer steel shell and the refractory material linings are in intimate contact with the graphite lining.

It is important for the lining structure to exhibit superior heat transfer, i.e., to have good thermal conductivity numbers, in order to effectively cool the edge regions of the molten bath so that a frozen slag layer is formed and maintained. The thermal conductivity should be at least 35 W/m·K and it is preferably in the range 120 W/m·K and 200 W/m·K.

It is also quite important, especially in the context of the carbothermic reduction of alumina that the graphite linings be substantially resistant to CO attacks and that they have a low Fe content of less than 0.1%. The novel refractory material linings are chemically and physically resistant against the molten slag. The preferred lining is thus formed with corundum (aluminum oxide), and more preferably with corundum bonded by 25% Sialon.

The use of graphite furnace linings is well known in blast furnaces. In the case of the carbothermic reduction of alumina, however, graphite, which is a highly structured type of carbon, would be consumed according to reaction (1), albeit not nearly as fast as the low-structured carbon species added to the melt. The graphite therefore needs to be protected by a thin layer of a refractory material that is chemically and physically resistant against the molten slag. This protection is especially important during the furnace start-up phase and to ensure that it does not contaminate the melt.

The material can be corundum, which is a special form of aluminum oxide (Al₂O₃). During the critical start-up phase it can resist the molten slag and, because it is chemically identical, it does not leach any contaminants into the melt. According to reaction (1) it is, however, consumed to slight extent during start-up before a frozen slag layer finally forms and protects its surface from further consumption. A further improvement of chemical stability can be provided by using Sialon-bonded corundum. Sialon is commercially available, by way of example, from Saint-Gobain Ceramics, which provides such materials for use as ceramic cups in blast furnaces.

Sialon is a silicon nitride ceramic with a small percentage of aluminum oxide added. The chemical formula of Sialon is Si₍₆₋ₓ₎AlₓOₓN₍₈₋ₓ₎, with x<4.2. The benefit of Sialon, in this context, is a dramatic improvement in thermal stability and overall corrosion resistance that are conferred by high x values.

In case of a production accident, the melt may overheat, thus melting the frozen slag layer on the inner corundum lining which is then being gradually consumed. During that period, the adjacent graphite lining, exhibiting very good thermal conductivity, would quickly dissipate the heat in the axial as well as in the radial direction to the outer parts of the furnace. By the time, the graphite gets attacked by the melt eventually broken through the thin corundum lining, the melt temperature will have already significantly dropped to a point where it will start forming a frozen slag layer. Even if this effect is locally somewhat delayed, at temperatures below about 1000° C. the graphite material provides an effective barrier against further chemical attack by the melt.

Graphite linings commonly used for blast furnaces and other applications contain more than 0.1% Fe. Since the pressurized hot carbothermic reduction furnace atmosphere is saturated with CO gas, it will leak through the inner corundum lining and preferably react with the Fe-containing domains of the graphite lining. To ensure longevity of the graphite lining, it should contain only traces of Fe of less than 0.1%. In a further embodiment of this invention, a low-iron coke, more preferably anode coke, is used as the raw material to reach the required purity level of the final graphite lining. Anode grade coke is a very pure coke with a minimal iron content.

Other features which are considered as characteristic for the invention are set forth in the appended claims.

Although the invention is illustrated and described herein as embodied in a liner for a carbothermic reduction furnace, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of an exemplary implementation of the invention, including specific examples and embodiments of the invention.

### BRIEF DESCRIPTION OF THE DRAWING FIGURES

FIG. 1 is a partial perspective view of a graphite lining block with a protective refractory layer on one surface of the block;

FIG. 2A is a partial sectional view taken through a lining block with a corundum coating formed on one surface of the block;

FIG. 2B is a similar section taken through a furnace lining with the protective refractory layer formed of corundum tile glued to the block; and

FIG. 3 is a partial section taken through the wall of a reactor vessel with a steel shell and a lining structure according to the invention.

### DETAILED DESCRIPTION OF AN EXEMPLARY EMBODIMENT

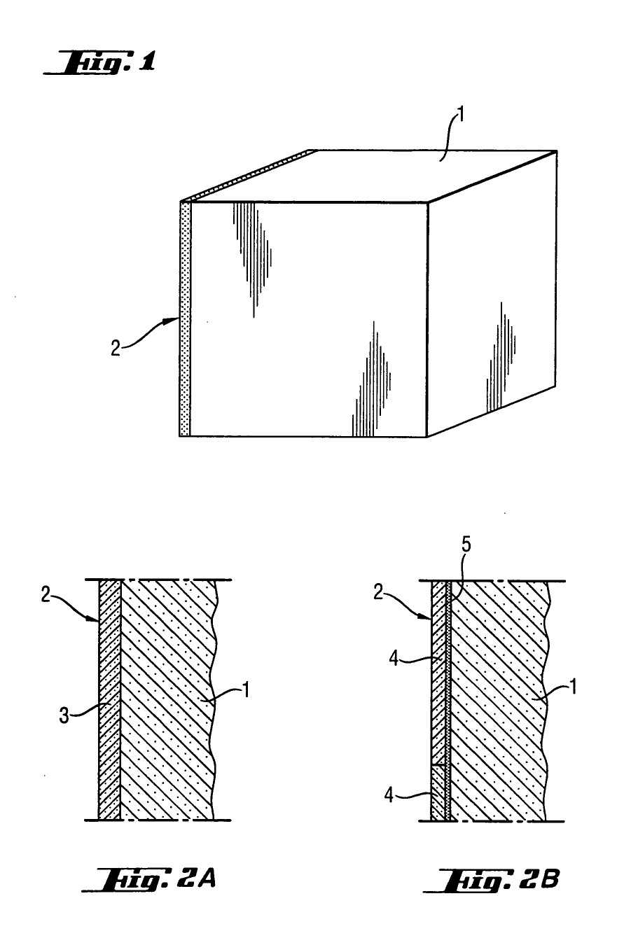

Referring now to the figures of the drawing in detail and first, particularly, to FIG. 1 thereof, there is shown diagrammatic view of a graphite block 1 forming a building block for the lining according to the invention. The graphite block 1 carries a thin protective refractory layer 2 on one of its surfaces. In a preferred embodiment of the invention, the protective layer 2 is a corundum layer in the form of a coating layer or a tile layer. The protective layer 2 is very thin relative to the graphite block 1. The thickness of the layer 2 is more than two orders of magnitude, and typically nearly three orders of magnitude, less than the thickness of the block 1. For example, the corundum coating is about 3 mm thick and the corundum tile layer is about 0.5 to 2 mm thick. The graphite block, in one preferred embodiment, is about 1.2 m (1200 mm) thick.

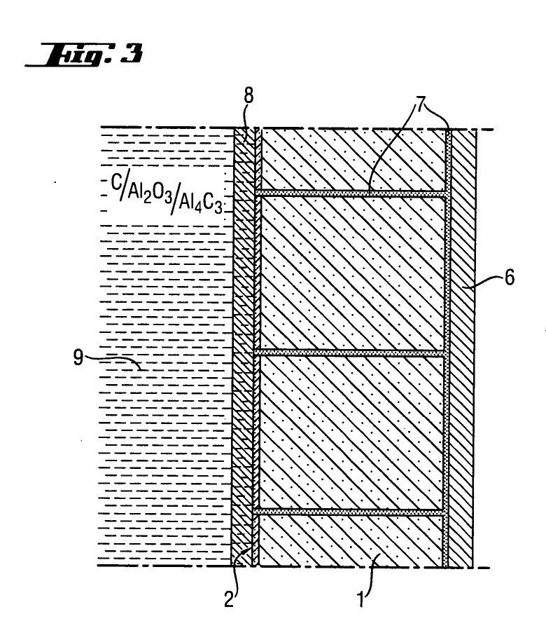

As shown in FIG. 2A, the protective layer 2 is a coating layer 2 that forms an intimate bond with the graphite block 1. In a preferred embodiment, a slurry of approx. 75% fine powder of corundum and approx. 25% Sialon is deposited on the block 1 and then baked at a temperature of approx. 2500° C. The resulting coating coating layer 3 has a thickness of approx. 3 mm.

In an alternative embodiment, which is illustrated in FIG. 2B, the protective layer 2 may also be formed by gluing corundum tiles 4 on the graphite block 1. The corundum tiles 4 have a thickness of 0.5-1 mm. They are rather thin, because the protective layer 2 is primarily important for protecting the furnace shell and, more specifically, the graphite block 1, during the initial start-up. The tiles 4 may have a flat dimension of 75 mm×75 mm or 100 mm×100 mm.

The tiles 4 are glued to the block 1 with a high-temperature cement 5. The high-temperature cement, or high-temp glue, consists of about 50% (w/w) finely ground graphite particles and resin which, upon complete processing, becomes carbonized. The resin may be a phenolic-based resin, or furanic resin, or epoxy resin.

Referring now to FIG. 3, there is illustrated a partial section of a steel shell 6 of a carbothermic reduction furnace. The lining on the inner wall surface of the shell is formed of a plurality of graphite blocks 1 that are glued to the steel shell 6 and to one another with a high-temperature cement or glue 7. The protective layer 2 on the tightly placed blocks 1 forms a contiguous protective layer with narrow grout lines of high-temperature glue 7. The same cement 7 may be used to glue the blocks to the steel shell 6 and to glue the blocks 1 together. It is important, thereby, to assure that the glue is high-temperature resistant, and does not impair the high thermal conductivity of the liner structure. In other words, the cement 7 has to exhibit good thermal conductivity.

Upon furnace start-up, the graphite linings expand slightly and this pressure as well as the heat achieve curing of the cement 7. This assures sufficient tightness in between the blocks 1 and good thermal contact also to the steel shell.

As shown in FIG. 3, the furnace is used for carbothermic reduction of alumina. The hot melt 9 contains a mixture of carbon (C), aluminum oxide (Al₂O₃), and aluminum carbide (Al₄C₃). The illustration also includes a frozen slag layer 8 that forms during regular operation of the furnace.

The following examples are presented to further illustrate and explain the present invention. They should not be viewed as limiting in any regard. Unless otherwise indicated, all parts and percentages are by weight.

### EXAMPLE 1

82 parts calcined low-iron coke and 18 parts of pitch having a softening point of 110° C. (Mettler) are mixed at 150° C., in an intense mixer with high energy input for 15 min. The mixture was extruded at 115° C. The extruded block was calcined for 3 to 4 weeks in a Riedhammer-type ring furnace with a final firing temperature of 900° C.

The thus obtained blocks were impregnated with impregnation pitch in autoclaves at 250° C. and pressures up to 25 bar. Afterwards they were rebaked within 1-3 weeks in rebaking furnaces at 1000° C. followed by graphitization in Castner type furnaces in firing rates up to 20 h at final temperatures surpassing 2800° C. The thus obtained graphite blocks were finally machined to the required dimensions.

### COMPARATIVE EXAMPLE 1

The same procedure was carried out using, instead of the low-iron anode grade coke, conventional needle coke with a high iron content as raw material for the graphite lining.

### EXAMPLE 2

A graphite block obtained according to example 1 was machined to blocks of 1 m×1 m (height×width) and 1.2 m depth. One of the 1 m×1 m surfaces was coated with a slurry of 75% finely ground corundum and 25% Sialon particles which was heat treated to final temperatures above 2500° C. The thus obtained coating had a thickness of 3 mm.

The coated graphite lining was joined by high-temperature glue with other graphite linings manufactured in the same manner to a solid lining wall inside a carbothermic reduction furnace steel shell.

| | | Graphite (low | Graphite/ | Graphite |
|---|---|---|---|---|
| Lining type | | Fe content) | Sialon | (conventional) |
| Bulk Density | (g/cm³) | 1.65 | 1.65 | 1.63 |
| Open Porosity | (%) | 20 | 21 | 24 |
| Coefficient of linear | (μm/K · m) | 2.5 | 2.4 | 1.1 |
| thermal expansion | | | | |
| (20 to 200° C.) | | | | |
| Thermal Conductivity | (W/m · K) | 150 | 122 | 150 |
| Iron content | (%) | 0.005 | 0.005 | 0.2 |

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

1. In a carbothermic reduction furnace, a reactor vessel, comprising:
an outer shell having an inner wall surface; and
a lining structure disposed on said inner wall surface and protecting said outer shell against attack from molten slag inside the reactor vessel, said lining having a relatively thick base layer of graphite disposed on said inner wall surface and a relatively thin refractory material layer on said base layer of graphite and in intimate contact therewith.

2. The reactor vessel according to claim 1, wherein said lining structure has a thermal conductivity of at least 35 W/m·K.

3. The reactor vessel according to claim 1, wherein said lining structure has a thermal conductivity of between 35 W/m·K and 200 W/m·K.

4. The reactor vessel according to claim 1, wherein said lining structure has a thermal conductivity of between 120 W/m·K and 200 W/m·K.

5. The reactor vessel according to claim 1 configured for carbothermic reduction of alumina, wherein said outer shell is a steel shell and said lining structure is formed to protect the molten slag of alumina against iron contamination from said steel shell and said steel shell against CO attack.

6. The reactor vessel according to claim 1, wherein said lining structure is configured to be substantially resistant to CO attack and to have a low Fe content of less than 0.1% by weight.

7. The reactor vessel according to claim 1, wherein said refractory material layer is a corundum layer.

8. The reactor vessel according to claim 7, wherein said refractory material layer is formed of corundum and approximately 25% by weight Sialon.

9. The reactor vessel according to claim 1, wherein said refractory material layer is thinner than said base layer of graphite by more than two orders of magnitude.

10. The reactor vessel according to claim 7, wherein said refractory material layer is formed of a plurality of corundum tiles attached to said base layer of graphite with a high-temperature glue based on graphite particles dispersed in a resin.

11. The reactor vessel according to claim 10, wherein said resin is selected from the group consisting of phenolic resin, furanic resin, and epoxy resin.

12. A method of producing a lining structure for a carbothermic reduction furnace, which comprises:
mixing a major proportion of calcined low-iron coke with a minor proportion of pitch at a temperature above a softening point of the pitch and forming the mixture into one or more blocks;
calcining the blocks to form calcined blocks;
impregnating the calcined blocks with impregnation pitch, rebaking the impregnated blocks, calcining the blocks, and machining the calcined blocks;
coating at least one surface of each of the blocks with a slurry comprising ground corundum, and heat treating the slurry to form a refractory coating on and in intimate contact with the at least one surface of the graphite blocks; and
joining the blocks to form a solid lining of a carbothermic reduction furnace, with the surface having the refractory coating facing an interior of the furnace.

13. The method according to claim 12, wherein the mixing step comprises providing approximately 82 parts of anode grade coke and approximately 18 parts pitch and mixing at a temperature of approximately 150° C.

14. The method according to claim 12, wherein the coating step comprises coating with a slurry of approximately 75% finely ground corundum and approximately 25% Sialon particles, and heat treating the slurry at a temperature of approximately 2500° C.

15. The method according to claim 12, wherein the coating step comprises forming the refractory layer to a thickness of approximately 3 mm.

16. The method according to claim 12, which comprises machining the blocks to a substantially final dimension of approximately 1 m×1 m×1.2m.

17. The method according to claim 12, wherein the calcining step comprises calcining at a calcining temperature above 2800° C.

18. The method according to claim 12, which comprises forming the mixture into the blocks by extruding the mixture.
